(19) United States
(12) Patent Application Publication
(10) Pub. No.: US 2013/0035945 A1
(43) Pub. Date: Feb. 7, 2013

(54) Method for Increasing Patient Compliance With Screening While Reducing Associate Professional Liability

(71) Applicant: Lee Walker Beville, III, Midland, TX (US)

(72) Inventor: Lee Walker Beville, III, Midland, TX (US)

(21) Appl. No.: 13/197,548

(22) Filed: Aug. 3, 2011

(51) Int. Cl. G06Q 50/00; G06Q 40/00

(52) U.S. Cl. 705/2

(57) ABSTRACT

In accordance with the present invention, methods consistent with the present invention increase patient compliance with screening while reducing economic risk to health service providers. In one embodiment of the invention, a patient acknowledges informed consent for a particular medical service, agrees to arbitrate any disputes arising from the service, accepts an insurance policy, and undergoes the service. The premium for the insurance policy is a function of certain risk factors, including factors associated with the patient, the particular service, and the health service provider. In the event of an unfavorable outcome, the policy proceeds are paid to the patient.

### BACKGROUND OF THE INVENTION

1. Field of the Invention

The present invention relates to patient screening and methods of reducing economic risk associated with diagnoses from that screening and enhancing net revenue from the provision of the screening.

2. Description of Related Art Including Information Disclosed Under 37 CFR 1.97 and 1.98

The practice of various forms of patient screening is currently a losing proposition for those providing the screening service. High professional liability insurance, pricing pressure from the public and private sectors, the ever-present threat of litigation, compliance with regulatory oversight commissions, and auditing the skills and qualifications of the personnel who provide these much needed services are all contributing factors to this unfortunate predicament.

A prime example of the crisis related to patient screening is mammography. Detection of breast cancer in the preclinical phase can prevent breast cancer from advancing, which then reduces the mortality rate from breast cancer in a population. The incidence of breast cancer is about 122.9 cases per 100,000 women. That rate varies with different factors, such as age and race. The lifetime risk of breast cancer is about 12.15%, but that number can be higher or lower, depending on the previously mentioned factors.

Mammography is tightly regulated by the Food and Drug Administration (FDA). According to the FDA website, as of Oct. 1, 2009, a total of 8,713 certified facilities with 12,437 mammography units operated in the United States. However, as of Jul. 1, 2010, that number had dropped from 8,713 to 8,649. Of the facilities inspected, 81.1% had no violations of the rules and regulations governing mammography. At these facilities, between 38 and 44 million mammograms are performed each year. Yet, the potential number of patients needing mammography is much higher, probably on the order of 100 million women each year. Many women do not obtain screening because of psychological factors including the fear of cancer and the possible economic consequences.

Additionally, the mobility of patients hinders the ability of service providers to identify and verify patients (and insured parties) when they receive particular services in different locations. Many patients have the same name and birthdate which creates confusion and identity ambiguity for service providers.

Humans make decisions without rationalizing the outcomes of their choices. When faced with multiple choices, the free option is commonly chosen. With the opportunity to receive something for free, the actual necessity and value of the product or service is taken for granted. The cost of patient screening, such as mammography, is often transparent to the patient since a third party usually pays for the service, or the patient pays a small amount in conjunction with a third party payment. The sensitive nature of the exam thus becomes a factor in patients avoiding the screening. Additionally, the lack of substantial payment by the patient leads to the perception that a service is overvalued. Misperceptions, such as the common notion that a mammography prevents breast cancer, can lead to undesirable, though anticipated, patient reactions to screenings.

### BRIEF SUMMARY OF THE INVENTION

Methods consistent with the present invention increase patient compliance with screening while reducing economic risk to health service providers. In one embodiment of the invention, a patient enters a health service provider testing facility. The patient answers a questionnaire appropriate for a particular service (e.g. a mammogram). The service provider then enters a code for the particular service that the patient needs. A computer algorithm performs a database lookup and assigns risk ratings for the particular service and patient. Additionally, a computer algorithm performs a database lookup and assigns a risk rating for the health service provider. The patient acknowledges informed consent for a particular medical service after being presented with information regarding the service. Further, the patient agrees to arbitrate any disputes arising from the service, such as the misdiagnosis of cancer. The patient receives an offer to purchase an insurance policy relevant to the particular service if the patient receives a favorable result from an initial administration of the particular service. The insurance policy protects the insured against unfavorable results of the particular service, not for the malpractice of the service provider. The premium for the insurance policy is a function of certain risk factors, including factors associated with the patient, the particular service, and the health service provider. Further, biometric data of the patient is used for identification purposes for subsequent visits.

In one embodiment, in the event of a favorable outcome from the service provided, the patient returns to the health service provider after a certain amount of time. The certain amount of time is set by the insurance policy and can be a function of the service provided. The patient undergoes the same service for a second time. The health service provider then diagnoses the results of the second service. In the event of an unfavorable outcome from the second service, the policy proceeds are paid to the patient. In the event of a favorable outcome, the patient continues to pay the insurance policy premium and returns to the health service provider after a certain amount of time to receive the particular service again. This process repeats as long as the service results in a favorable outcome. In the event of an unfavorable outcome, the policy proceeds are paid to the patient.

### BRIEF DESCRIPTION OF THE SEVERAL VIEWS OF THE DRAWING(S)

The present invention will be more fully understood by reference to the following detailed description of one embodiment of the present invention when read in conjunction with the accompanying figures, wherein:

FIG. 1 is a flowchart of the patient and service risk rating formulations in one embodiment of the invention;

FIG. 2 is a flowchart of the service provider and policy limit and premium calculation formulation in one embodiment of the invention;

FIG. 3 is a flowchart of an exemplary method for reducing economic risk associated with patient screening;

FIG. 4 is a depiction of a database and the corresponding fields used to calculate a risk factor for a patient.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form one embodiment will be explained or will be within the skill of the art after the following teachings of the present invention have been read and understood.

### DETAILED DESCRIPTION OF THE INVENTION

Before describing in detail exemplary embodiments that are in accordance with the present invention, it is noted that the embodiments reside primarily in combinations of processing steps related to implementing a method for reducing economic risk associated with patient screening. Accordingly, the method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

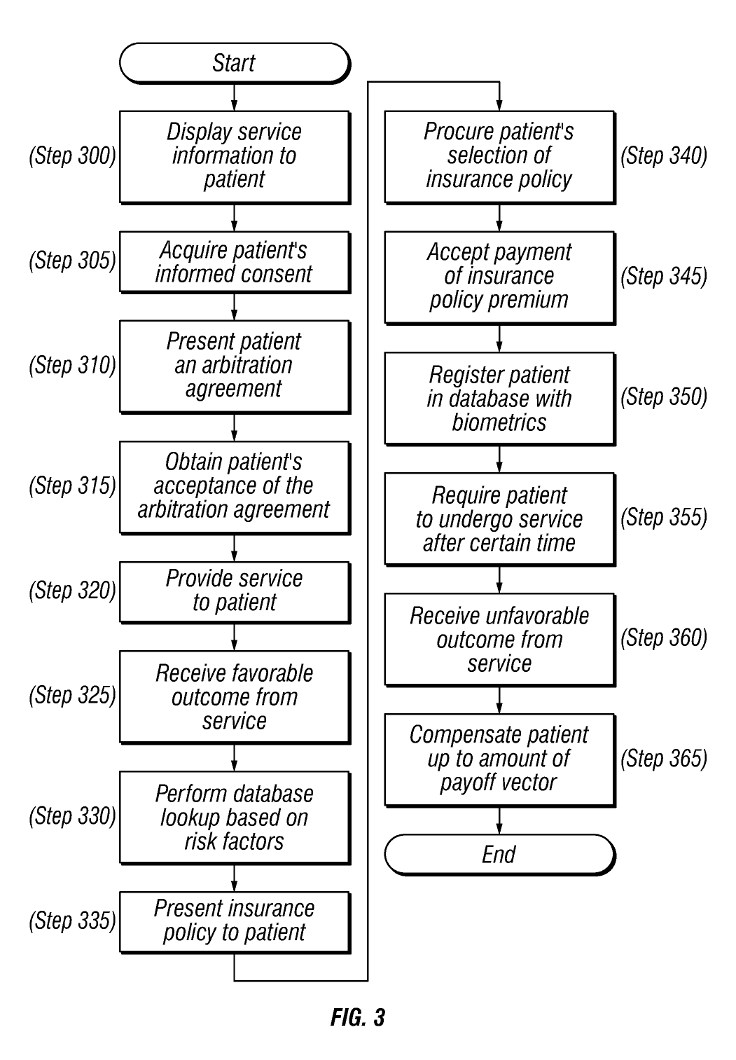

The present invention is a method for reducing economic risk to health service providers by offering insurance to patients against unfavorable outcomes from particular services provided to patients by health service providers (hereinafter “service provider(s)”). Also included in the Method is a mandatory arbitration agreement. For explanatory purposes only, one embodiment of the invention will be discussed in terms of mammography and breast cancer detection. Several embodiments of Applicant's invention will now be described with reference to FIG. 3, which depicts a process diagram of one embodiment of the current invention. Although this embodiment shall be described sequentially, nothing in this disclosure should be taken to limit the invention to a set sequence.

In one embodiment, the first step is displaying to a patient information regarding a particular service (STEP 300). The patient's treating physician may have ordered a particular service, such as a mammogram, to be performed by the service provider. However, the particular service is not limited to mammography. Other examples include blood tests, pap tests, and colonoscopies. Determining the particular service (11) to be performed for the patient may he trivial if the patient's treating physician ordered the service. The information displayed to the patient might comprise statistics regarding the particular service, including error rates, probability of a false positive, probability of a false negative, known side effects of the service, and a description of the actual treatment process. This information might be provided in a brochure format, orally, or through a video display device.

In one embodiment, the next step is acquiring from the patient an informed consent acknowledgment regarding limitations of the particular service (STEP 305). For example, a mammography service provider may inform the patient of the probability of being diagnosed with breast cancer. An example informed consent acknowledgement may comprise the data that eight patients out of one thousand may have breast cancer; however mammography will only correctly diagnose seven out of eight of those patients. The informed consent acknowledgement could be spoken or written. If written, the patient must sign the informed consent acknowledgement to receive the particular service. If the patient refuses to sign the informed consent acknowledgement, the service provider does not provide the particular service to the patient.

In one embodiment, the next step is presenting the patient with an arbitration agreement (STEP 310). The arbitration agreement comprises a written contract with terms including any dispute regarding a diagnosis or with billing will be subject to resolution via arbitration. As used herein, “arbitration” means alternative dispute resolution including binding arbitration, non-binding mediation, summary jury trials, and mini-trials.

In one embodiment, the next step is obtaining from the patient an acceptance of the arbitration agreement (STEP 315). The service provider must obtain from the patient an acceptance of the arbitration agreement to receive the health service. As used herein, “acceptance” means an express act or implication by conduct that manifests assent to the terms of an offer in a manner invited or required by the offer so that a binding contract is formed. If the patient refuses to accept the arbitration agreement, the service provider may elect to not provide the particular service to the patient.

In one embodiment, the next step is providing the particular service to the patient (STEP 320). The service provider simply performs the particular service for the patient. Continuing with the mammography example, at this step, the service provider would perform the patient's mammogram.

In one embodiment, the next step is receiving a favorable outcome from the particular service (STEP 325). As used herein, “favorable outcome” means the desired or hoped-for outcome from the perspective of the patient. At this step, the results of the particular service are analyzed by the service provider. In the mammography example, results are categorized under Breast Imaging-Reporting and Data System (hereinafter “BI-RADS”). BI-RADS, in common usage, refers to the to the mammography assessment categories. The categories are standardized numerical codes typically assigned by a radiologist after interpreting a mammogram. This allows for concise and unambiguous understanding of patient records between multiple service providers. BI-RADS categories are: 0—incomplete; 1—negative; 2—benign finding; 3—probably benign; 4—suspicious abnormality; 5—highly suggestive of malignancy; 6—known biopsy or proven malignancy. For a favorable outcome from the mammogram, the service provider would need to classify the outcome under BI-RADS category 1 or 2. In another example, for a favorable outcome for a screening for Acquired Immune Deficiency Syndrome (“AIDS”), the service provider would need to classify the outcome as “HIV-negative.” If a favorable outcome is received from the particular service, the patient is eligible to continue through the method.

In one embodiment, the next step is performing at least one database lookup based on at least one risk factor to determine at least one insurance policy premium and payoff vector (STEP 330). In one embodiment, at least one risk factor is associated with a patient. In another embodiment, at least one risk factor is associated with the service provider. In another embodiment; at least one risk factor is associated with the particular service. In another embodiment, risk factors associated with the patient, the service provider, and the particular service are used to determine the amount of the premium.

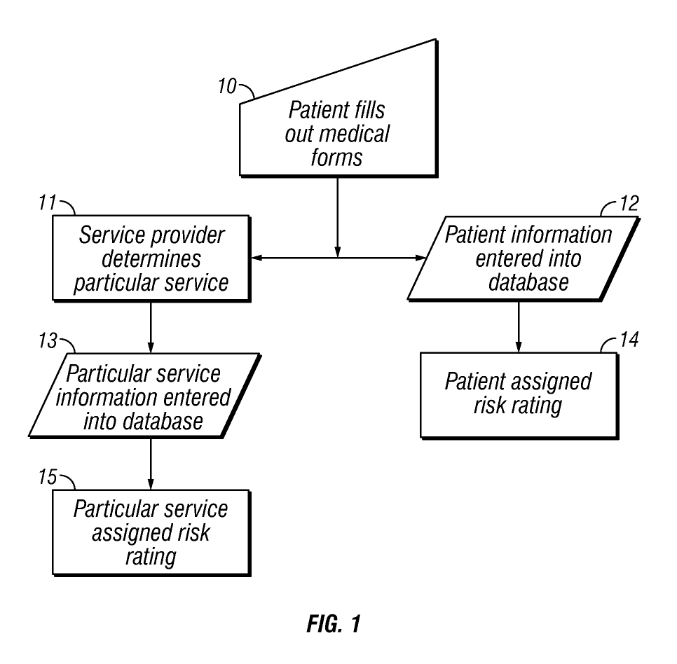

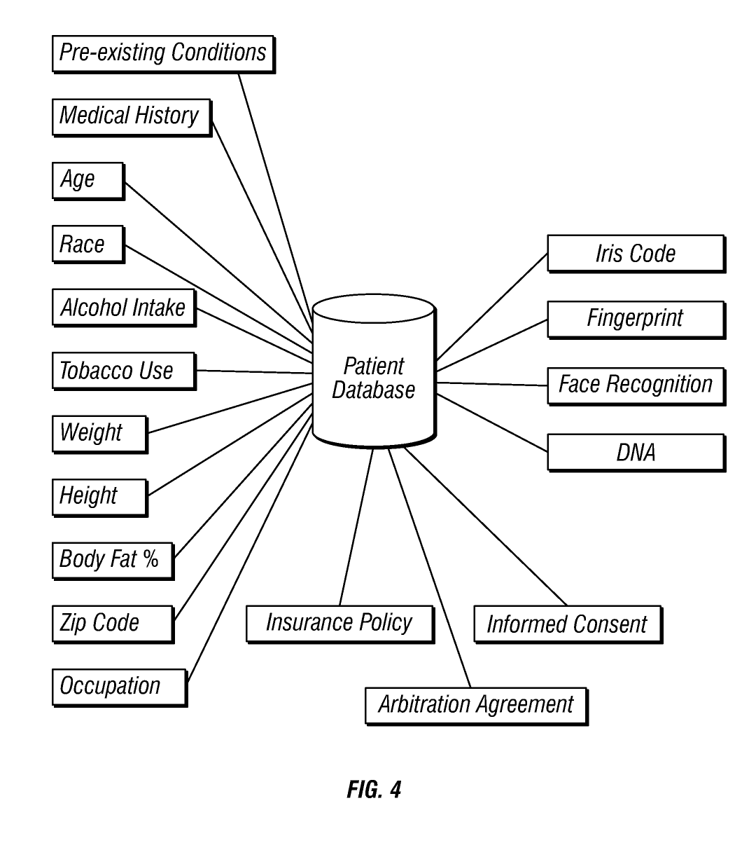

Patient risk factors are extracted from questionnaires or other sources. In one embodiment, risk factors associated with the patient are selected from the group consisting of pre-existing conditions, medical history, age, race, alcohol intake, tobacco use, weight, height, occupation, zipcode, and combinations thereof. As shown in FIG. 1, the patient fills out medical forms (10) with fields comprised of pre-existing conditions, medical history, age, race, alcohol intake, tobacco use, weight, height, occupation, and zipcode. The data from the forms are entered into a database (12) (see FIG. 4). The database can be physically located on-site at the service provider, at a remote site, or a combination thereof. Additionally, the database may contain data solely related to the patient, service provider, particular service, or any combination thereof. Further, the database may be accessed by either hardwired connection or wirelessly. Computer processes operate on that data and perform a database lookup based on at least one risk factor to establish a risk rating, which is then assigned to the patient (14). A depiction of the database for patient risk ratings, including the data fields mentioned above, is shown in FIG. 4. The data from the questionnaires can also be used by the service provider to determine a particular service (11) required for the patient (again, a mammogram), although this may be unnecessary if the patient has an order for a particular service from her treating physician.

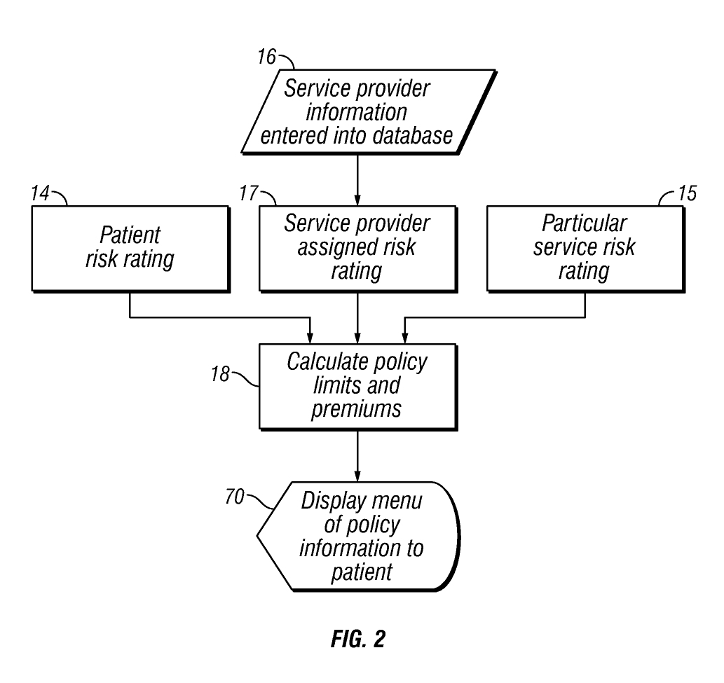

Service provider risk factors are extracted from various data. In one embodiment, risk factors associated with the service provider are selected from the group consisting of malpractice history, specialty, location, occurrences of true positives, occurrences of true negatives, occurrences of false positives, occurrences of false negatives, occurrences of callbacks, and combinations thereof. As shown in FIG. 2, information regarding the service provider is also entered into a database (16). The database could be the same database as described in steps 12 and 13, or the database may be a separate database containing solely information regarding the service provider. Computer processes operate on that data and perform a database lookup based on at least one risk factor to establish a risk rating, which is then assigned to the service provider (17). Factors included in determining the service provider's risk rating include the service provider's malpractice history, specialty, and location. Then, the patient risk rating (as calculated in 14), the particular service risk rating (15), and the service provider risk rating (17) are inputs for a computer-based calculation to determine the insurance premiums corresponding to certain payoff vectors (18). Hence, performing at least one database lookup based on at least one risk factor determines the policy premiums with corresponding policy limits. In one embodiment, the risk factors associated with the patient, the service provider, and the particular service are used to determine the amount of the premium via database lookups.

Particular service risks are extracted from various data. In one embodiment, risk factors associated with the particular service are selected from the group consisting of probability of a false positive, probability of a false negative, error rates, known side effects, and combinations thereof. In one embodiment, the health service provider performs a step of entering a code associated with the particular service. Codes for the particular service may be taken from the American Medical Association's Current Procedural Terminology (“CPT”). For example, the code entered for a bilateral mammography from the CPT would be “77056.” The particular service information is entered into a database (13). The database may be the same database as previously disclosed (see 12), or the database may be a separate database containing solely information regarding the particular service. Computer processes operate on the data and perform a database lookup based on at least one risk factor to establish a risk rating, which is then assigned to the particular service (15).

Importantly, the insurance policy in one embodiment is a policy that pays the insured for an unfavorable outcome of the particular service and does not cover malpractice by the service provider.

In one embodiment, the insurance policy is a term insurance policy. The term insurance policy avoids the problem of moral hazard. Moral hazard occurs when a party insulated from risk behaves differently than it would behave if fully exposed to the risk and can more easily be explained in the context of mammography. If the patient has a lump or other problem which would necessitate a diagnostic mammogram, and she does not disclose the lump or other problem at the time of the service, the outcome of the service would be unfavorable (e.g. the result of the particular service would be unfavorable, as opposed to the favorable outcome in STEP 325). Hence, the patient would not be provided the opportunity to purchase the insurance policy. If the patient had a problem that was not disclosed, the initial mammogram produced favorable results, and the subsequent mammogram was positive for cancer, the insurance policy proceeds would not be relatively large.

The term insurance policy also minimizes the problem of adverse selection. Adverse selection is a market process in which undesirable results occur when buyers and sellers have access to different information. In the mammography example, a patient may be aware that she carries a higher risk of malignancy due to genetic predisposition. Setting a single price for all prospective customers runs a higher risk for insurers than selling insurance to only those with a lower risk of malignancy. The payoff vector increases as the patient is compliant with the periodic schedule of the particular service and payment of the insurance premium. As used hereinafter, “payoff vector” means the amount the patient will receive if the patient is eligible to collect on the insurance policy. In breast cancer diagnosing, genetic markers for the predilection of developing cancer create adverse selection. In many cases, the genetic marker predilection is relatively low, and patients generally do not know that they have a predilection. In one embodiment, other predilections for the development of breast cancer such as a family member with breast cancer are not included in determining whether a patient may continue with the process; only a mammogram result categorized as BI-RADS 1 or 2 from STEP 325 is used as a selection criterion.

The term insurance policy also encourages the participants to adhere to the screening schedule. Once the patient has entered into the disclosed method, the cost of terminating the method early becomes prohibitive. Behavioral economics and the particular rational choice theory known as the “dollar auction” support the preceding proposition. The dollar auction is a non-zero-sum sequential game in which players with perfect information in the game are compelled to ultimately make an irrational decision based on rational choices made throughout the game. This concept is also sometimes known as irrational escalation of commitment. Regardless of the economic underpinnings, patients often prefer to have insurance against breast cancer. The payoff vector is utilized to reinforce commitment of the patient. For example, the term policy could begin with the ability of the patient to pay up to $500 for the first year in premiums, $500 for the second year premiums, and produce a $2500 payoff vector after the second year if she develops breast cancer. In this example, the payoff multiple is five. Additionally, after the first two years, the premium limit can be raised, and each year the payoff vector is increased by not only the amount of the premium paid, but also by the payoff multiple. For instance, if the patient has paid $5000 over a period of seven years, the payoff multiple may approach ten (for a payoff vector of $50,000). In one embodiment, the payoff multiple is determined by the use of Monte Carlo computational algorithms. Monte Carlo algorithms are a class of computational algorithms that rely on repeated random sampling to compute their results. One skilled in the art would understand the methods of Monte Carlo computation algorithms and their application to insurance premium, payoff multiple, and payoff vector calculations.

In one embodiment, the next step is presenting the at least one insurance policy premium and payoff vector to the patient (STEP 335). In one embodiment, the payoff vector is the amount of money paid by the patient in premiums multiplied by the payoff multiple. During the presenting step, insurance premiums are displayed to the patient along with corresponding potential payoff vectors. As the payoff vector is as function of the amount of money paid by the patient and the payoff multiple, more than one potential payoff vector per insurance policy may be displayed. For illustration only, the policies presented to the patient might comprise the following: for a payoff vector of $25,000, the premium is $250; for a payoff vector of $50,000, the premium is $500; and for a payoff vector of $75,000, the premium is $750. In each of these illustrations, if a payoff multiple of 10 is used, the patient would need to pay the premium at least 10 times to be compensated up to the amount of the displayed payoff vector. A patient who has paid 10 premiums of $250 has paid a total of $2,500. Here, the payoff vector is simply the product of the amount paid by the patient multiplied by the payoff multiple, which in this case is 10. Thus, one of the displayed payoff vectors is the amount projected to be paid by the patient, $2,500, multiplied by the payoff multiple, 10, for a payoff vector of $25,000. These example insurance policies can be displayed through electronic means, such as a television or computer monitor, or the insurance policies can be displayed in paper format.

In one embodiment, the next step is procuring a selection from the patient of at least one insurance policy premium and payoff vector (STEP 340). The patient selects the insurance policy by accepting the policy and entering into a contractual obligation to pay the premium in consideration of a potential payout in the event of an unfavorable outcome of the particular service. The patient may select one of the insurance policies by executing a contract associated with a specific insurance policy.

In one embodiment, the next step is accepting payment of at least one insurance policy premium (STEP 345). The patient pays an insurance premium to the insurance policy company in consideration for coverage. The payment may be required at the service provider's facility or it may be delayed to some later date. The patient may make the payment through various media, including cash, check, and credit card.

In one embodiment, the next step is registering the patient in a patient database using at least one biometric identifier (STEP 350). As used hereinafter, “biometric identifier” means an objective measurement of a physical characteristic of an individual person (e.g., a patient) which, when captured in a database, can be used to verify the identity of that person or check against other entries in the database. In one embodiment, the patient database contains the patient's name, age and other demographic data. The patient database also contains the iris code and other biometric data (“the biometrics”) which are recorded at the time of the contract. A computer registers the biometrics and associates them with the demographic data and the insurance policy specifications in the patient database. The patient database may store a scanned image of documents at the time of enrollment in the insurance policy, such as the signed insurance policy contract, copies of the informed consent, and the arbitration agreement. The patient database may be stored at a location other than the service provider. If stored in a central location, multiple service providers can access the information stored in the patient database. Using biometric identifiers helps disambiguate patients with identical names and birthdates. In one embodiment, the patient database is the same database as previously disclosed (see 12 and FIG. 4). In one embodiment, the biometric identifiers are selected from the group consisting of iris recognition, fingerprint, face recognition, DNA, palm print, hand geometry, odor, and combinations thereof. Additionally, using multiple biometric identifiers adds redundant identification measures, which further helps service providers resolve ambiguities for patient identification. The patient database helps alleviate the problem of identifying patients who are mobile. Since patients will routinely move during the course of their lives, patients will often receive particular services from different service providers in different locations. A patient database with biometric identifiers can more easily and accurately identify patients enrolled in an embodiment of the present invention.

In one embodiment, the next step is requiring the patient to undergo the particular service after a certain period of time (STEP 355). In this step, the particular service is the same service as performed in STEP 320. The certain period of time can be a function of the particular service in question. Typically, mammograms are performed once a year. Hence, the certain amount of time in the mammography example is 365 days.

In one embodiment, the next step is receiving an unfavorable outcome from the particular service after the certain period of time (STEP 360). In the mammography example, an unfavorable outcome of the mammogram is a biopsy proven cancer, as indicated by a BI-RADS category 4 (suspicious abnormality) or 5 (highly suggestive of malignancy) recommendation for biopsy. BI-RADS category 6 (known biopsy) is not used in typical practice. In the AIDS screening example, an unfavorable outcome is a “HIV-positive” result. If the patient receives a favorable outcome from the particular service (e.g. BI-RADS category 1 or 2 for a mammogram), the patient may continue to pay the insurance premium. Additionally, the service provider will encourage the patient to return to the service provider, after an additional certain period of time, to receive the particular service again. In other words, the patient may repeat the particular service without limit, while also continuing to pay the insurance premium throughout the course of treatment.

In one embodiment, the next step is compensating the patient up to the payoff vector (STEP 365). If the patient receives an unfavorable outcome from the particular service after the certain period of time, the patient is eligible to be compensated up to the payoff vector. In other words, the patient is paid up to the amount of the policy limit if an unfavorable result occurs from the later particular service.

In one embodiment, a computer uses Monte Carlo computational algorithms to model inputs such as age and the probability of developing cancer during the term of the insurance policy. Since health service providers perform over 36 million mammograms each year across all age groups, computationally intensive predictive algorithms are needed. Each age group has its own statistical probability of developing cancer. Additionally, the pool of money to pay off patients who have developed cancer must be determined. By using a Monte Carlo method, the patient will receive the highest payoff based on the number of other patients in the pool. The instantaneous probability of the insurance pool is liquid. In addition to the Monte Carlo computational algorithms, other traditional, actuarial methods can be utilized and compared to the Monte Carlo outcomes. Monte Carlo methods can be applied to calculate policy limits and premiums (18).

In one embodiment, a computer manages the patient's appointment for the next particular service and sends telephone and mail reminders of the amount of money she has paid in premium and her expected payoff if she receives an unfavorable result from the particular service.

In one embodiment, a computer database also maintains information about the competence of the health service provider. In the mammography example, the service provider is a radiologist. Measurements of true positive, true negative, false positive and false negative decisions and the number of callbacks for additional images are important metrics for the service provider. This information may be derived from other programs which are designed specifically to measure or audit the physician.

In one embodiment, the health service provider performs a patient filter step before presenting at least one insurance policy premium and payoff vector to the patient (the presenting step being the same as STEP 335). In other words, the process includes a step of filtering the patient with a service different from the particular service provided in STEP 320 and STEP 355. The patient filter step decreases the amount of potential high risk patients by removing those patients from the process who show proclivity to unfavorable outcomes from the particular service. The patient filter step comprises a medical service provided to the patient, albeit a different service than that of the particular service. Additionally, the filtering step service has a different CPT code than the CPT code of the particular service. In the mammography example, the service different from the particular service in the filtering step comprises an ultrasound screening, while the mammogram is the particular service. Health service providers can determine patient breast density from the result of the mammogram. Since higher than 50% breast density can decrease the effectiveness of mammograms, a patient undergoes an ultrasound screening prior to the presentment of the insurance policy. If the patient's breast density level is below 50%, the patient may continue to another step in the disclosed method. If the patient's breast density level is 50% or above, the health service provider may still allow the patient to receive subsequent mammograms, but the health service provider will not perform any database lookup (STEP 330) or present an insurance policy to the patient (STEP 335), which eliminates the possibility of the patient completing the disclosed method. Additionally, the ultrasound screening has the added benefit of acting as a relatively cheap filter, as ultrasound screenings are inexpensive services compared to other medical screening services. Hence, the ultrasound screening filters out high risk patients.

In one embodiment, the health service provider is paid a commission after accepting payment of at least one insurance policy premium as disclosed in STEP 345. In other words, the process includes a step of paying a commission to the health service provider. As used hereinafter, a “commission” means a sum or percentage allowed to sales representatives for their services. For example, the health service provider would receive 10% of the first premium paid by the patient as a commission payment. Paying the health service provider a commission gives the health service provider an economic incentive to encourage patients to select an insurance policy and continue through the disclosed method.

It is to be understood that the present invention is not limited to the embodiment described above, but encompasses any and all embodiments within the scope of the following claims.

### Additional Description

The following clauses are offered as further description of the disclosed invention.

1. A method for reducing economic risk associated with patient screening comprising the following steps:
displaying to a patient information regarding a particular service;
acquiring from the patient an informed consent acknowledgment regarding limitations of the particular service;
presenting the patient with an arbitration agreement;
obtaining from the patient an acceptance of the arbitration agreement;
providing the particular service to the patient;
receiving a favorable outcome from the particular service; and
performing at least one database lookup based on at least one risk factor to determine at least one insurance policy premium and payoff vector;
presenting said at least one insurance policy premium and payoff vector to the patient;
procuring a selection from the patient of at least one of said insurance policy premium and payoff vector;
accepting payment of said at least one insurance policy premium; and
registering the patient in a patient database using at least one biometric identifier.

2. The method for reducing economic risk associated with patient screening according to any preceding clause, wherein the biometric identifiers are selected from the group consisting of iris recognition, fingerprint, face recognition, DNA, palm print, hand geometry, odor, and combinations thereof.

3. The method for reducing economic risk associated with patient screening according to any preceding clause, further comprising the following step:
entering a code for associated with the particular service.

4. The method for reducing economic risk associated with patient screening according to any preceding clause, further comprising the following steps:
requiring the patient to undergo the particular service after a certain period of time;
receiving an unfavorable outcome from the particular service after the certain period of time; and
compensating the patient up to the payoff vector.

5. The method for reducing economic risk associated with patient screening according to any preceding clause, wherein the at least one insurance policy premium and payoff vector is at least one insurance policy premium and payoff vector for a term insurance policy.

6. The method for reducing economic risk associated with patient screening according to any preceding clause, wherein obtaining the acceptance of the arbitration agreement and accepting payment of the premium occurs before providing the particular service to the client.

7. The method for reducing economic risk associated with patient screening according to any preceding clause, wherein at least one risk factor is associated with the patient.

8. The method for reducing economic risk associated with patient screening according to any preceding clause, wherein at least one risk factor is associated with the service provider.

9. The method for reducing economic risk associated with patient screening according to any preceding clause, wherein at least one risk factor is associated with the particular service.

10. The method for reducing economic risk associated with patient screening according to any preceding clause, wherein:
at least one risk factor is associated with the patient;
at least one risk factor is associated with the service provider;
at least one risk factor is associated with the particular service; and wherein
the risk factors associated with the patient, the service provider, and the particular service are used to determine the amount of the premium.

11. The method for reducing economic risk associated with patient screening according to any preceding clause, further comprising the following step:
filtering the patient with a service different from the particular service; wherein said filtering step occurs before the presenting said at least one insurance policy premium and payoff vector to the patient.

12. The method for reducing economic risk associated with patient screening according to any preceding clause, further comprising the following step:
paying a commission.

13. The method for reducing economic risk associated with patient screening according to any preceding clause, wherein the risk factors associated with the patient are selected from the group consisting of pre-existing conditions, medical history, age, race, alcohol intake, tobacco use, weight, height, occupation, zipcode, and combinations thereof.

14. The method for reducing economic risk associated with patient screening according to any preceding clause, Wherein the risk factors associated with the service provider are selected from the group consisting of malpractice history. specialty, location, occurrences of true positives, occurrences of true negatives, occurrences of false positives, occurrences of false negatives, occurrences of callbacks, and combinations thereof.

15. The method for reducing economic risk associated with patient screening according to any preceding clause, wherein the risk factors associated with the particular service are selected from the group consisting of probability of a false positive, probability of a false negative, error rates, known side effects, and combinations thereof.

16. The method for reducing economic risk associated with patient screening according to any preceding clause, wherein a computer is used to determine the premium and the database of risk factors is stored on at least one computer.

We claim:

1. A method for reducing economic risk associated with patient screening comprising the following steps:
displaying to a patient information regarding a particular service;
acquiring from the patient an informed consent acknowledgment regarding limitations of the particular service;
presenting the patient with an arbitration agreement;
obtaining from the patient an acceptance of the arbitration agreement;
providing the particular service to the patient;
receiving a favorable outcome from the particular service; and
performing at least one database lookup based on at least one risk factor to determine at least one insurance policy premium and payoff vector;
presenting said at least one insurance policy premium and payoff vector to the patient;
procuring a selection from the patient of at least one of said insurance policy premium and payoff vector;
accepting payment of said at least one insurance policy premium; and
registering the patient in a patient database using at least one biometric identifier.

2. The method for reducing economic risk associated with patient screening according to claim 1, wherein the biometric identifiers are selected from the group consisting of iris recognition, fingerprint, face recognition, DNA, palm print, hand geometry, odor, and combinations thereof.

3. The method for reducing economic risk associated with patient screening according to claim 1, further comprising the following step:
entering a code for associated with the particular service.

4. The method for reducing economic risk associated with patient screening according to claim I, further comprising the following steps:
requiring the patient to undergo the particular service after a certain period of time;
receiving an unfavorable outcome from the particular service after the certain period of time; and
compensating the patient up to the payoff vector.

5. The method for reducing economic risk associated with patient screening according to claim 4, wherein the at least one insurance policy premium and payoff vector is at least one insurance policy premium and payoff vector for a term insurance policy.

6. The method for reducing economic risk associated with patient screening according to claim 5, wherein obtaining the acceptance of the arbitration agreement and accepting payment of the premium occurs before providing the particular service to the client.

7. The method for reducing economic risk associated with patient screening according to claim 5, wherein at least one risk factor is associated with the patient.

8. The method for reducing economic risk associated with patient screening according to claim 5, wherein at least one risk factor is associated with the service provider.

9. The method for reducing economic risk associated with patient screening according to claim 5, wherein at least one risk factor is associated with the particular service.

10. The method for reducing economic risk associated with patient screening according to claim 5, wherein:
at least one risk factor is associated with the patient;
at least one risk factor is associated with the service provider;
at least one risk factor is associated with the particular service; and wherein
the risk factors associated with the patient, the service provider, and the particular service are used to determine the amount of the premium.

11. The method for reducing economic risk associated with patient screening according to claim 5, further comprising the following step:
filtering the patient with a service different from the particular service;⁻wherein said filtering step occurs before the presenting said at least one insurance policy premium and payoff vector to the patient.

12. The method for reducing economic risk associated with patient screening according to claim 5, further comprising the following step:
paying a commission.

13. The method for reducing economic risk associated with patient screening according to claim 7, wherein the risk factors associated with the patient are selected from the group consisting of pre-existing conditions, medical history, age, race, alcohol intake, tobacco use, weight, height, occupation, zipcode, and combinations thereof.

14. The method for reducing economic risk associated with patient screening according to claim 8, wherein the risk factors associated with the service provider are selected from the group consisting of malpractice history, specialty, location, occurrences of true positives, occurrences of true negatives, occurrences of false positives, occurrences of false negatives, occurrences of callbacks, and combinations thereof.

15. The method for reducing economic risk associated with patient screening according to claim 9, wherein the risk factors associated with the particular service are selected from the group consisting of probability of a false positive, probability of a false negative, error rates, known side effects, and combinations thereof.

16. The method for reducing economic risk associated with patient screening according to claim 10, wherein a computer is used to determine the premium and the database of risk factors is stored on at least one computer.
